(19) United States
(12) Patent Application Publication
(10) Pub. No.: US 2008/0087176 A1
(43) Pub. Date: Apr. 17, 2008

(54) Foldable charcoal burner with skewers

(76) Inventor: Abdul Wakil Qayyeumi, Mississauga (CA)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/548,780

(22) Filed: Oct. 12, 2006

(51) Int. Cl. A47J 37/07

(52) U.S. Cl. 99/450

(57) ABSTRACT

A foldable grilling device is provided. The grilling device includes a foldable grilling area, metal skewers, and a grilling surface. The grilling area is comprised of hinged walls that allow the grilling area to fold flat. When assembled, the grilling area provides a charcoal pit and ash collection area. The metal skewers can be easily manipulated using a removable skewer handle and a kabob removing utensil. The grilling area, grilling utensils, and grilling surface all fit in a custom carrying case.

### FIELD OF THE INVENTION

The present invention is directed toward the field of outdoor grilling. Specifically, the present invention discloses a foldable metal barbeque that is notched to hold skewers and can be stored in a portable carrying case.

### BACKGROUND OF THE INVENTION

There are many products aimed at portable barbeque systems. Currently, these devices lack the capability to provide a collapsible barbeque grill made from light, yet durable metal which is easily foldable. In addition, these products lack the capability to be stored and carried in a convenient case and the additional benefit of providing and storing barbeque skewers.

For example U.S. Pat. Nos. 4,539,901, 4,621,608, 4,888,988, 5,174,197, 6,532,951 and 6,792,935 all disclose portable barbeque grills. However, none of these devices can be folded down to be easily stored in a carrying case.

Similarly, U.S. Pat. Nos. 4,646,711, 6,672,303 and 6,321,741 disclose barbeque grills that can be disassembled for storage purposes. These devices cannot be easily folded down, nor do they provide specifically designed carrying cases.

There have been many products developed that provide collapsible or portable barbeque grill stands. Examples of such are U.S. Pat. Nos. 5,163,414, 5,819,720 and 6,422,230. These products do not provide portable grill designs or carrying cases which can transport disassembled barbeque grills.

U.S. Pat. No. 6,439,111 is directed toward a collapsible barbecue grill that includes a body in a box shape capable of being pivoted with two side plates respectively disposed at both side walls thereof, and a cover plate disposed at a rear wall thereof. While this device may be disassembled for easy storage, it is not capable of easily being folded flat like the present invention.

Other disclosures are directed to foldable barbeque grills but do not contain areas where fuel, such as charcoal, may be added to heat the grill. For instance, U.S. Pat. No. 5,575,195 is directed toward a foldable outdoor cooking device, having wall assemblies which are hinged and foldable and when erected, form an enclosure. The device may be used with gaseous fuels or may be positioned on a pan so wood or charcoal can be used as a fuel.

Presently, there is a need for a foldable barbeque grill comprising of lightweight and durable material that provides an area for fuel storage, that can be easily folded down to a space saving form, and that can be transported in a convenient specially designed carrying case.

Accordingly, the present invention encompasses these elements to create a foldable metal barbeque grill as described herein.

### BRIEF SUMMARY OF THE INVENTION

It is an object of the present invention to provide a foldable metal barbeque grill made from a lightweight durable metal.

It is a further object of the invention to provide a grilling surface which can be placed atop the foldable barbeque grill and stored along with the grill once it has been folded for transport or storage.

It is a further object of the invention to provide skewers that can be placed in notches on the foldable grill. The skewers have releasable handles and the food from the skewers can be readily removed using grilling utensils that are also provided.

It is a further object of the invention to provide a charcoal pit that is used to heat the grilling surface and skewers.

It is a further object of the invention to provide a resilient, hard plastic carry case which can be used to transport the grill. The carry case also provides spaces to transport the skewers and other barbeque utensils.

### BRIEF DESCRIPTION OF SEVERAL VIEWS OF THE DRAWING

The accompanying drawings, which are incorporated herein and constitute a part of the specification, illustrate presently preferred embodiments of the invention, and together with the general description given above and the detailed description given below, serve to explain the principles of the invention.

FIG. 1 illustrates a perspective view showing the various components of the grilling device.

FIG. 2 illustrates a perspective view showing the hinged movement of the walls in accordance with the present invention.

FIG. 3 illustrates a perspective view of the grilling area in accordance with the present invention.

FIG. 4a illustrates a perspective view of the charcoal pit in accordance with the present invention.

FIG. 4b illustrates a cross sectional view of the charcoal pit in accordance with the present invention.

FIG. 5 illustrates a perspective view of the grilling surface in accordance with the present invention.

FIG. 6 illustrates a perspective view showing the side walls of the grilling area in accordance with the present invention.

FIG. 7 illustrates a perspective view showing the side and bottom walls of the grilling area in accordance with the present invention.

FIG. 8 illustrates a perspective view showing the bottom wall of the grilling area in accordance with the present invention.

FIG. 9 illustrates a perspective view of the grilling skewers in accordance with the present invention.

FIG. 10 illustrates a perspective view of the present invention in use.

FIG. 11 illustrates a perspective view of the grilling utensils in accordance with the present invention.

FIG. 12 illustrates a perspective view of the carrying case in accordance with the present invention.

### DETAILED DESCRIPTION OF THE INVENTION

It will be readily understood that the components of the present invention, as generally described herein, could be arranged and designed in a wide variety of different formulations. Thus, the following more detailed description of the embodiments of the compositions or formulations of the present invention are not intended to limit the scope of the invention, as claimed, but are merely representative of the presently preferred embodiments of the invention.

Reference will now be made in detail to the presently preferred embodiments of the invention, examples of which are illustrated in the accompanying drawings, wherein like reference numerals refer to like elements throughout.

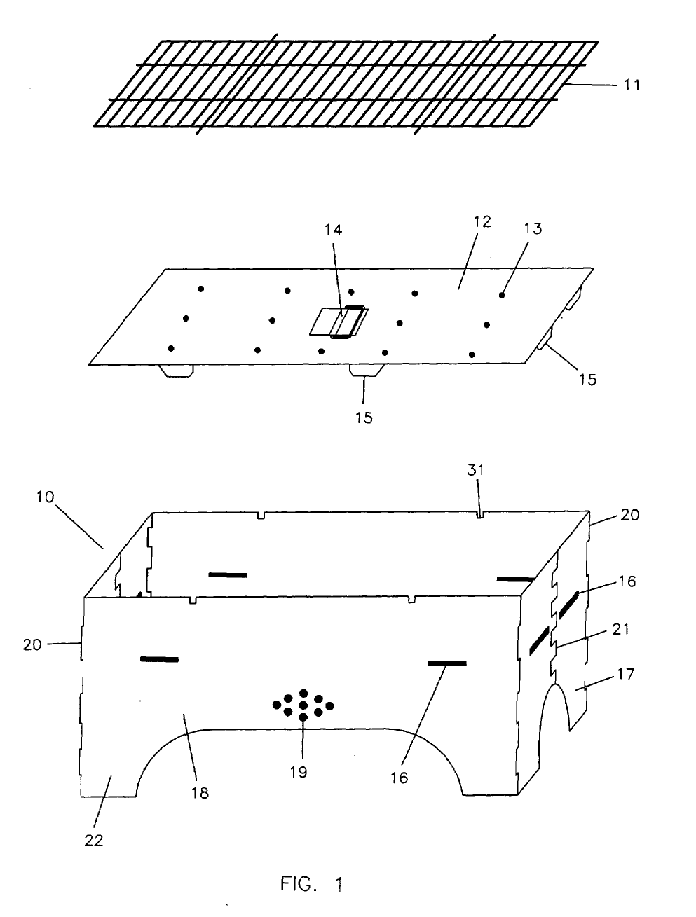

Referring to FIG. 1, the present invention comprises a grilling device 10, the partition 12 which separates the charcoal pit from ash collection area and a grilling surface 11. The components of the grilling device will be made from a light, strong metal.

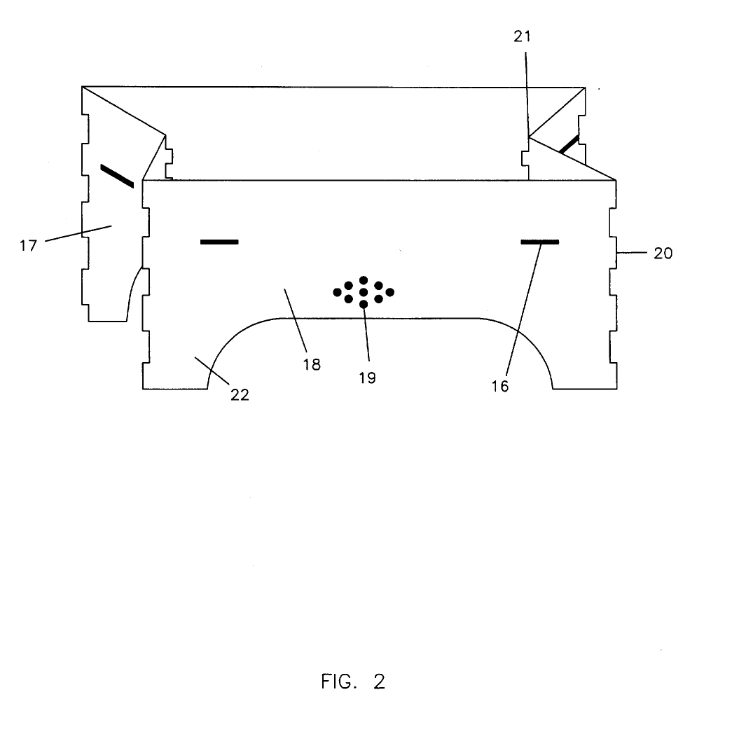

FIG. 2 depicts the walls of the grilling device 10. The longer side walls 18 are connected to the shorter side walls 17 at a hinge point 20. The bottom corners where the longer side walls 18 and the shorter side walls 17 meet form the four legs 22 of the grilling device 10. The shorter side walls 17 are hinged at their center 21 so that the walls can be folded inward. When the grilling device 10 is folded, the shorter side walls 17 fold inward at the hinge point 21. The longer side walls 18 then fold flat above and below the shorter side walls 17.

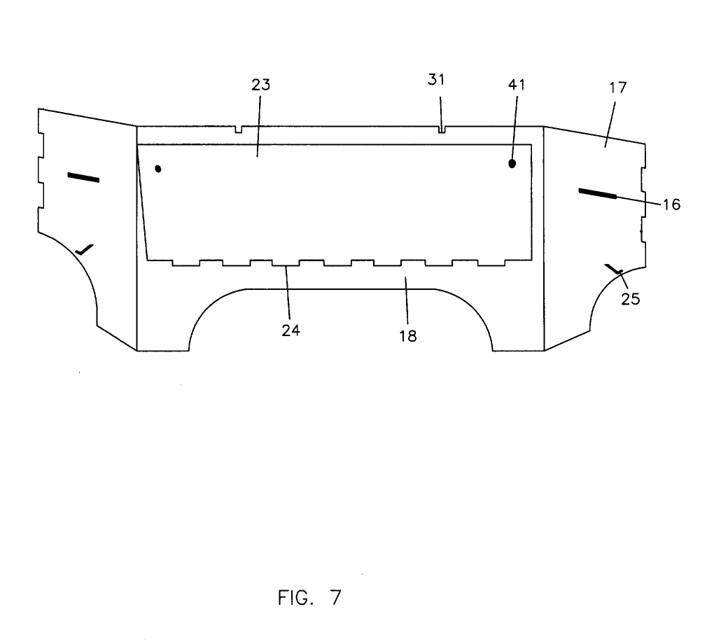

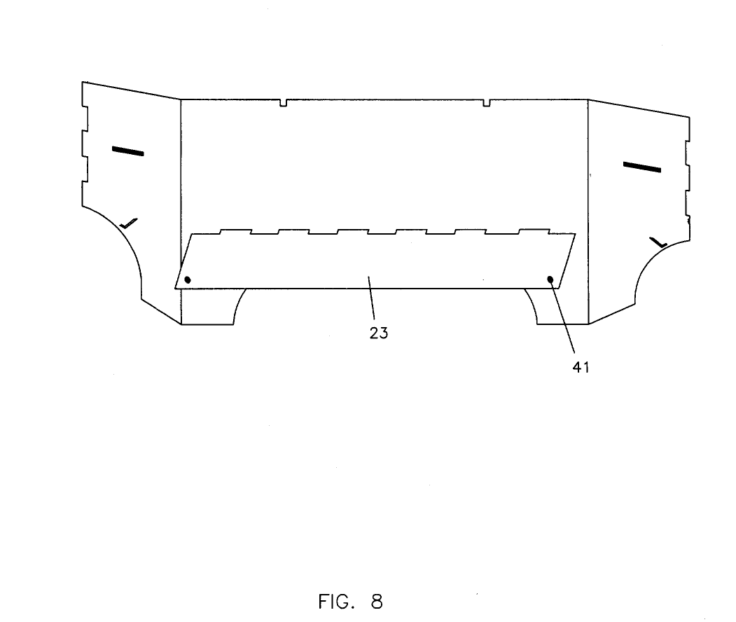

FIGS. 7 and 8 show the rectangular segments 23 that are connected to form the bottom wall of the grilling device 10. The rectangular segments 23 are connected to the longer side walls 18 at a hinge point 24. The rectangular segments fold upward when the grilling device 10 is folded flat. One rectangular segment will be longer than the other. This segment will fall over the shorter rectangular segment to form the bottom wall of the grilling device 10. The shorter rectangular segment is secured to the shorter side walls by the slot hooks 25 that are connected to the side walls 17. The slot hooks 25 are inserted into the slots 41 found on the lower ends of the shorter rectangular segment 23. When the rectangular segments 23 are connected, they form the bottom wall of the grilling device 10.

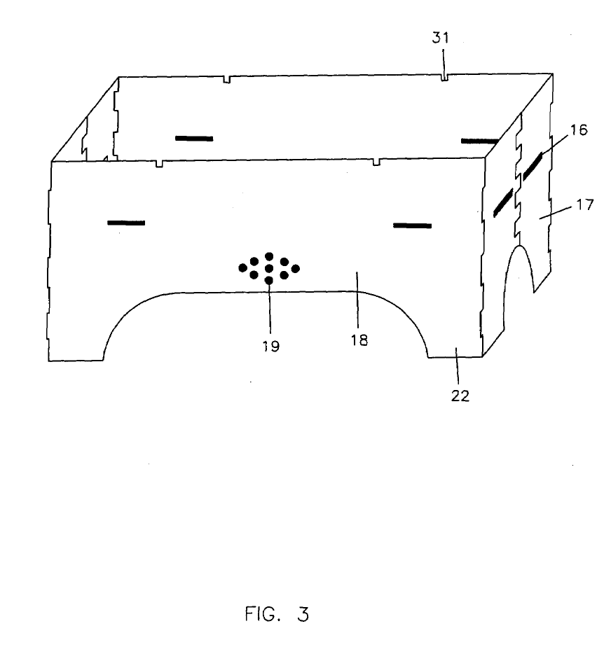

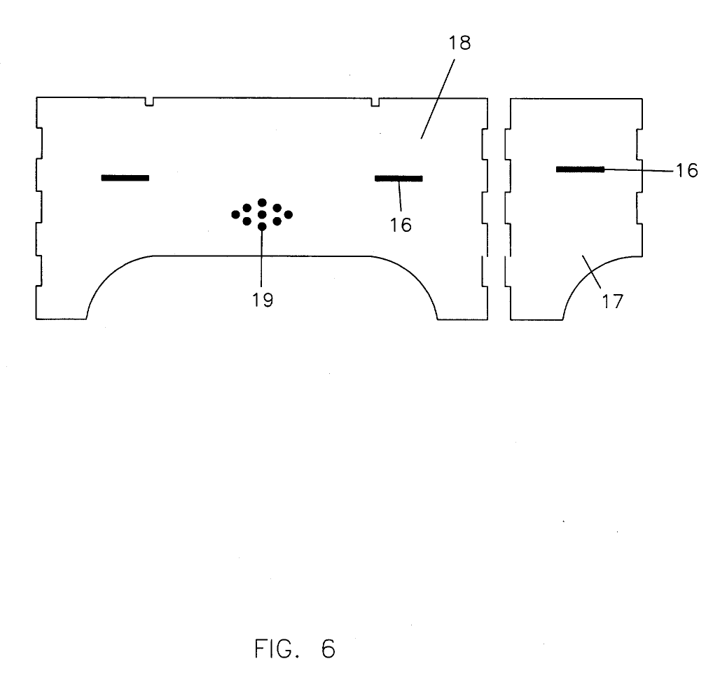

Referring to FIGS. 3 and 6, the dimensions of the grilling device 10 are shown. The height of the side walls, which forms the height of the grilling device 10, is twelve inches. The length of longer side walls 18, which forms the length of the grilling device 10, is twenty-four inches. The length of shorter side walls 17, which forms the length of the grilling device 10, is twelve inches. The height of the legs 22 of the grilling device 10 to the bottom of the longer side walls 18 is five inches. From the bottom of the side walls 18, to the hinged point 24 where the rectangular segments meet the longer side walls, form the bottom of the grilled area and create a half inch space. There is two and a half inches of space between the bottom wall and the slots 16. This forms the height of the ash collection area. From the slots 16 to the top of the grilling device 10, there is a space of four inches. This forms the height of the charcoal pit.

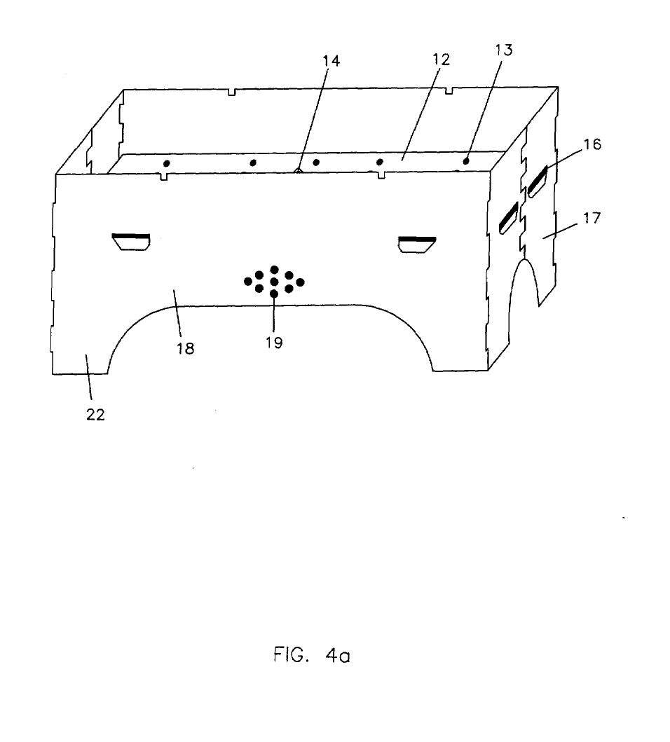

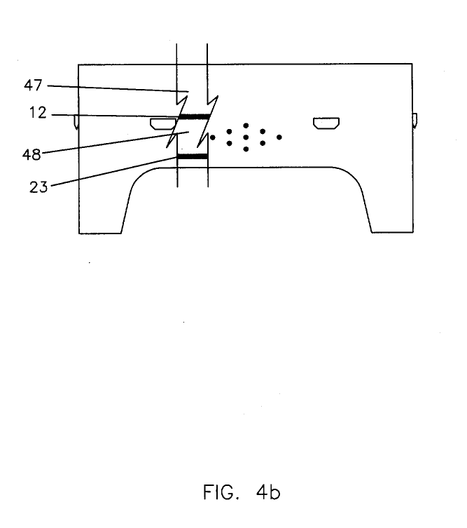

Referring now to FIG. 4a and FIG. 4b, the partition 12 which separates the ash collection area 48 and the charcoal pit 47 is shown inserted into the grilling device 10. The partition 12 is twenty-four inches in length and twelve inches in width. The area above the partition 12 is the charcoal pit 47 where charcoal can be added to heat the grilling surface 11 or skewers 26. The partition 12 contains a plurality of holes 13 where ashes can be released to the ash collection area 48 below the charcoal pit. There is a handle 14 in the center of the partition 12 so that it can be placed or removed from the grilling device 10. The partition 12 is secured to the grilling device 10 though flaps 15 that are perpendicularly connected to the partition 12. These flaps 15 fit into slots 16 which are located in the side walls of the grilling device 10. This forms a secure fit and creates the charcoal pit 47 above the partition 12 and the ash collection area 48 below the partition 12. The ash collection area 48 is ventilated by holes 19 which are cut into the longer side walls 18.

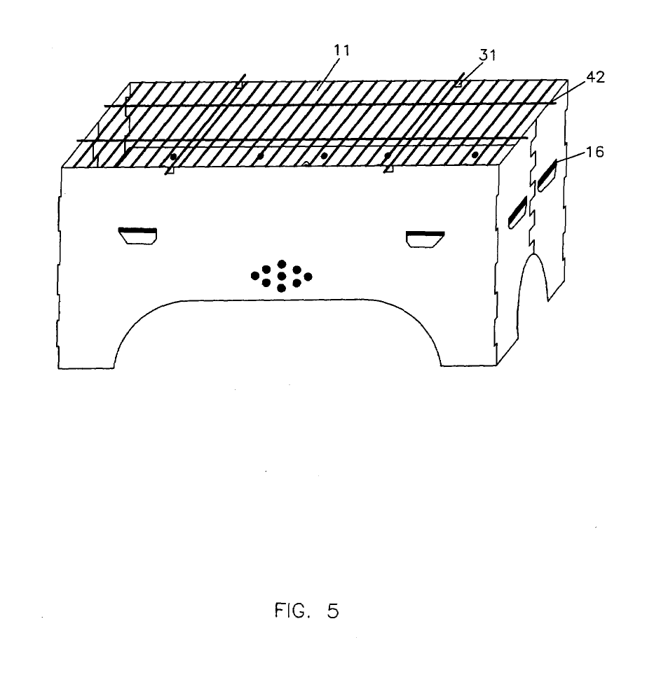

FIG. 5 shows the grilling surface 11 fitted over the grilling device 10. The grilling surface 11 fits into notches 31 located on the top of the longer side walls 18 and notches 42 located on the top of the shorter side walls 17. The grilling surface is comprised of a plurality of metal rods which are connected by four long metal rods running perpendicularly to them.

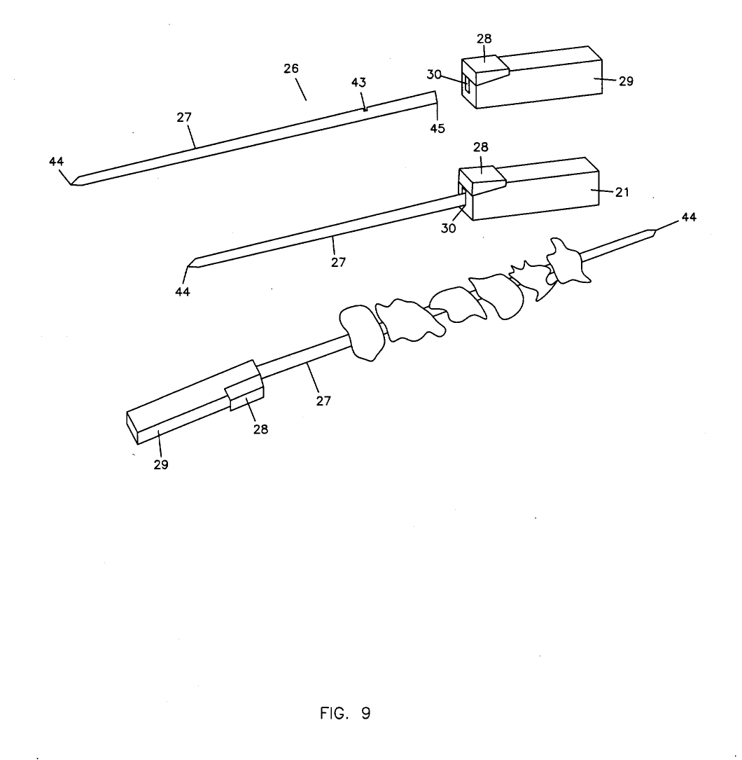

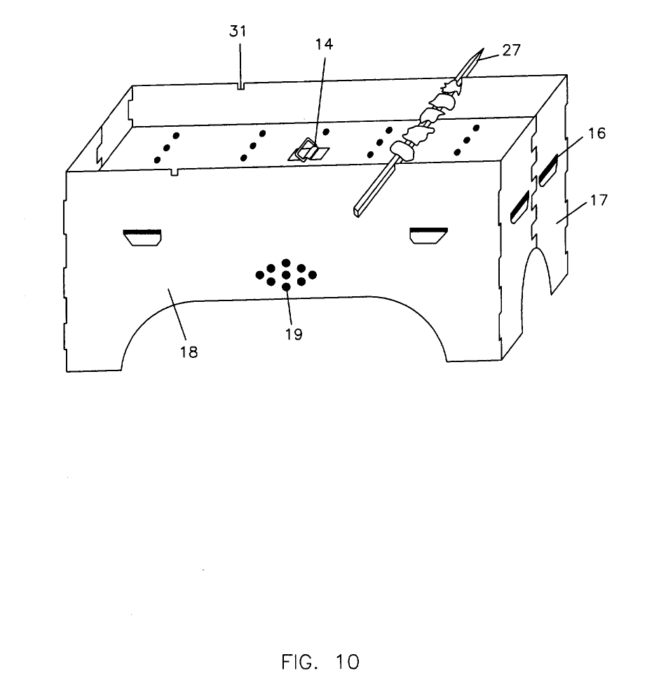

Referring to FIG. 9, the skewers 26 for use with the grilling device are shown. The skewers are comprised of a flat metal skewer 27, which is used to hold foods used in grilling, and a removable wooden skewer handle 29. The metal skewers 27 are approximately twenty inches in length and two and a half centimeters in height. The metal skewers 27 have a pointed end 44 used to pierce food and a flat end 45 that is inserted into the skewer handle. The metal skewers 27 have a notch 43 that is located five inches from the flat end 45. As best seen in FIG. 10, the metal skewers can be used with the grilling device 10 when the grilling surface 11 is removed. The metal skewers 27 can then be placed in the notches 31 of the grilling device 10 and are heated from the charcoal in the charcoal pit below. The grilling device 10 can hold approximately twenty-four metal skewers 27. The metal skewers 27 can be easily transported using the skewer handle 29. The wooden skewer handle 29 is six inches in length, one inch in height, and a half inch in width. The metal skewers fit into the slot 30 in the skewer handle 29. The skewer handle is fitted with a metal release button 28 used to secure the metal skewer in the skewer handle. When pressed down, the release button 28 fits into the notch 43 on the metal skewer 27 to hold it in place. When the metal skewer 27 is placed on the grilling device 10 for use, the skewer handle 29 can be removed by releasing the metal release button 28.

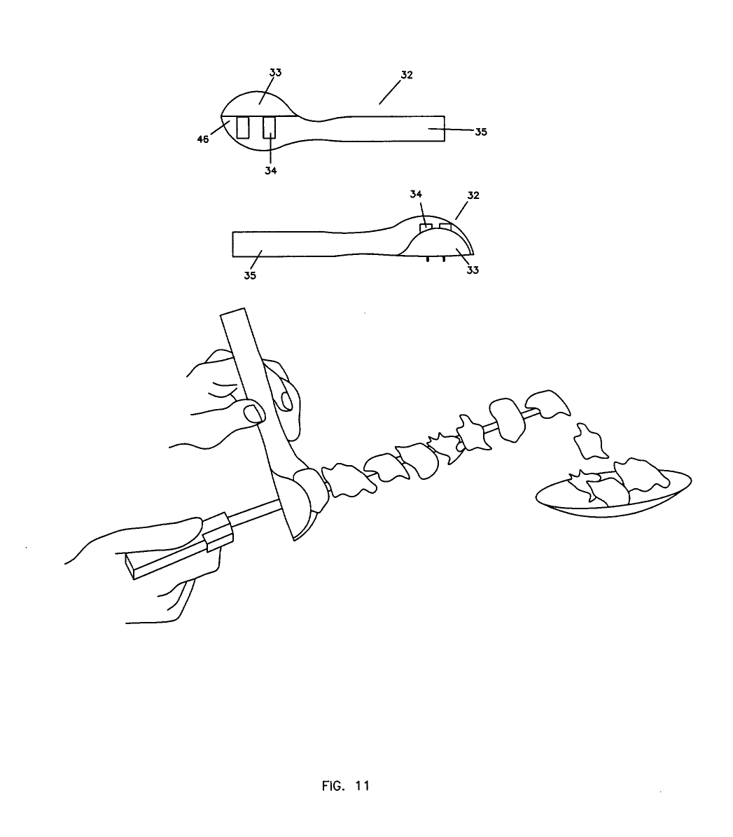

Referring now to FIG. 11, the kabob remover 32 is shown. The kabob remover 32 is approximately seven inches in length and one inch in height. One end of the kabob remover 32 has a semi-circular end 46 that has a diameter of approximately one inch. The semi-circular end 46 contains two rectangular slits 34. These slits 34 are approximately one and a half centimeters apart and are two centimeters in height and three and a half centimeters in width. There is a semi-circular metal flap 33 which is perpendicularly connected to the end 46 and has a diameter of approximately one inch. The two rectangular slits 34 fit over the metal skewers 27. The kabob remover 32 can then be used to remove grilled foods from the metal skewers 27 with the semi-circular metal flap 33 acting as a guide for the food.

When the grilling device 10 is folded, the shorter side walls 17 fold inward at the hinge point 21. The rectangular segments 23 which form the bottom wall fold upward at the hinge point 24 to lie flat against the longer side walls 18. The longer side walls 18 then fold flat above and below the shorter side walls 17. The folded grilling device 10 can then be easily stored in the carrying case 36.

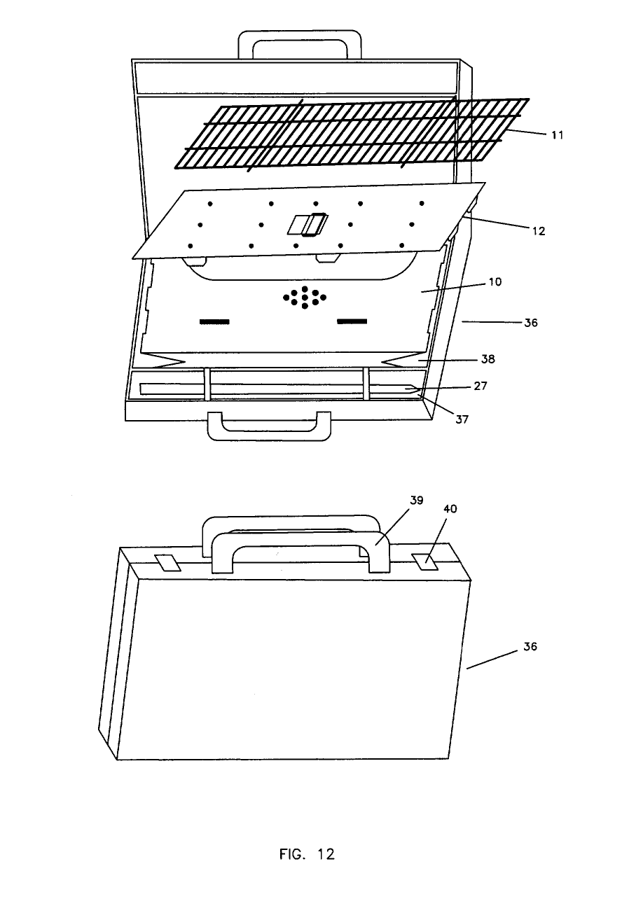

Referring now to FIG. 12, the carrying case 36 is shown. The carrying case 36 contains a compartment 38 for holding the grilling surface 11, the partition 12 for the charcoal area and ash collection area, and the folded grilling device 10. There is also a compartment 37 that can hold the skewers 26, the kabob removers 32 and other grilling utensils. The carrying case 36 also has a handle 39 and a locking component 40. The carrying case 36 is made from a sturdy plastic and is approximately twenty-five inches in length, thirteen inches in height, and five inches in width.

It is to be appreciated that additional advantages, modifications and equivalent embodiments will be apparent to those skilled in the art. Therefore, the invention, in its broader aspects, is not limited to the specific details and representative devices shown and described herein. Accordingly, various modifications may be made without departing from the spirit or scope of this invention as defined by the appended claims and their equivalents.

What I claim is:

1. A grilling device comprising:
a hinged assembly that can be folded to form a rectangular grilling area further comprising two longer sides, two shorter sides, a bottom wall, and four legs;
a partition which fits in said grilling area to create a charcoal pit and an area for ash collection;
a grilling surface which fits over said grilling area; and
a carrying case that can store the folded grilling device, partition, and grilling surface.

2. The grilling device of claim 1 wherein the grilling area and the grilling surface are constructed from a lightweight metal.

3. The grilling device of claim 1 wherein the top sides of the longer walls of the grilling area are notched to hold the grilling skewers.

4. The grilling device of claim 1 wherein the partition which fits in said grilling device to create a charcoal pit and an area for ash collection, further comprising:
flaps that are perpendicularly connected to the partition;
said flaps fitting into slots being located in the sides of the grill walls, so as to create a tight fit; and
a handle to facilitate placement and removal of the partition.

5. The grilling device of claim 1 wherein the carrying case comprises:
a compartment to hold the grilling skewers and other utensils;
a compartment to hold the collapsed grilling area, the grilling surface and the partition which separates the charcoal pit and ash collection area;
a handle to allow for convenient transport; and
a hard plastic material.

6. The grilling device of claim 1 wherein the bottom wall of the grilling area comprises two rectangular segments that are hinged to the longer side walls and secured together by two slot hooks located on the side walls of the grilling device and which fit into slots located on the rectangular segments.

7. A grilling skewer used to grill food comprising:
a flat metal rod being pointed on the first end with a second end fitting into a wooden handle;
a slot by which the rod can be secured to the handle;
said handle consisting of a hollow area wherein the metal rod is inserted; and
a securing latch attached to the wooden handle which is secured in the slot to readily attach and detach the metal rod from the wooden handle.

8. A grilling utensil used to remove grilled food from skewers comprising:
a flat handle;
a circular flat head affixed to said handle that is bent so that half of the circular head lies on the same plane as the handle with the other half faces perpendicularly upward; and
two rectangular slots located on the portion of the circular head that is located on the same plane as the handle which can be placed over a skewer to easily remove grilled foods from the skewer.
